(19) United States
(12) Patent Application Publication
(10) Pub. No.: US 2018/0067916 A1
(43) Pub. Date: Mar. 8, 2018

(54) ANALYSIS APPARATUS, ANALYSIS METHOD, AND RECORDING MEDIUM

(71) Applicant: HITACHI, LTD., Tokyo (JP)

(72) Inventors: Ryosuke TSUCHIYA, Tokyo (JP); Shuhei NOJIRI, Tokyo (JP); Katsumi KAWAI, Tokyo (JP); Nishio YAMADA, Tokyo (JP); Yusuke JIN, Tokyo (JP); Yasunari TAKAI, Tokyo (JP)

(73) Assignee: HITACHI, LTD., Tokyo (JP)

(21) Appl. No.: 15/598,484

(22) Filed: May 18, 2017

(30) Foreign Application Priority Data
Sep. 2, 2016 (JP) 2016-171935

(51) Int. Cl. G06F 17/24; G06F 17/21; G06F 17/27

(52) U.S. Cl. CPC G06F 17/246; G06F 17/27; G06F 17/245; G06F 17/212

(57) ABSTRACT

An analysis apparatus comprises a processor configured to execute a program; and a storage device configured to store the program and a document group having a spreadsheet format, the processor being configured to execute: acquisition processing for acquiring the document group from the storage device; classification processing for classifying documents in the document group acquired by the acquisition processing into at least one shared form group having a shared form based on a commonality relating to a character string included in a cell of each document among the documents in the document group and to a position of the cell including the character string; and output processing for outputting a classification result obtained by the classification processing.

### CLAIM OF PRIORITY

The present application claims priority from Japanese patent application JP 2016-171935 filed on Sep. 2, 2016, the content of which is hereby incorporated by reference into this application.

### BACKGROUND

This invention relates to an analysis apparatus, analysis method, and analysis program for analyzing information.

In system development, documents are created, for example, a specification in which system requirements are described and design documents in which design information on the system components is described. System development documents are often created in a spreadsheet format by spreadsheet software, for example, for the purpose of listing a large amount of specifications and design items in a table.

In order to check the quality of the system development documents and to perform mechanical processing like automatic program generation that utilizes information described in the system development documents, there is a method in which content described in system development documents having a spreadsheet format is converted into structured information and managed in an integrated manner on a database.

JP 2013-257852 A discloses a document conversion apparatus configured to convert a plurality of documents of different forms into structured information based on form definition information prepared for each document form. JP 2000-268040 A discloses an information classification method for classifying system development documents for each form by using a content feature and a formatting feature of formatted documents. JP 2011-248609 A discloses a report recognition apparatus configured to automatically recognize item information described in reports in a wide variety of forms by using a word dictionary of item names and item values prepared in advance.

The document conversion apparatus of JP 2013-257852 A is configured to convert documents based on form definition information prepared for each document form. However, JP 2013-257852 A does not disclose means for preparing the form definition information. Therefore, when there is a very large number and types of system development documents to be managed, a large number of man-hours are required to manually create the form definition information.

The information classification method of JP 2000-268040 A is not suited to classification of spreadsheet format documents that do not have layout attribute information on formatting and rulers, for example, a comma-separated value (CSV) format. Specifically, for example, in JP 2000-268040 A discloses that “for extraction of the content feature, for example, a weighted frequency vector of a word is generated based on the type and appearance frequency of the words appearing in a text document by using the above-mentioned TF/IDF method, for example, and the generated frequency vector is set as the content feature. However, for extraction of the formatting feature, for example, shared attribute area information in the page is generated by using a method of determining a positional match of the attribute area in the page, and the generated shared attribute area information is set as the formatting feature of the above-mentioned category.”

In system development, documents like system input setting files, report files to be batch-output, and application log files are often created or output as spreadsheet format documents that do not have layout attribute information. However, in the information classification method of JP 2000-268040 A cannot extract the formatting feature for documents that do not have layout attribute information, and cannot distinguish documents that have similar words appearing in the documents but have a different form.

With the report recognition apparatus of JP 2011-248609 A, when there are a large number and type of documents, similarly to the form definition information, a large number of man-hours are required to manually create the word dictionary.

### SUMMARY

This invention has been made in view of circumstances like those described above, and it is an object of this invention to classify a large variety and a large number of system development documents for each form without using added input, for example, layout attribute information on the documents or a word dictionary, and automatically generate form definition information on each form.

An aspect of the invention disclosed in this application is an analysis apparatus, comprising: a processor configured to execute a program; and a storage device configured to store the program and a document group having a spreadsheet format, the processor being configured to execute: acquisition processing for acquiring the document group from the storage device; classification processing for classifying documents in the document group acquired by the acquisition processing into at least one shared form group having a shared form based on a commonality relating to a character string included in a cell of each document among the documents in the document group and to a position of the cell including the character string; and output processing for outputting a classification result obtained by the classification processing.

According to the representative embodiment of this invention, a large variety and a large number of documents can be classified for each form without using added input, for example, layout attribute information on the documents or a word dictionary. Other objects, configurations, and effects than those described above are clarified by the following description of an embodiment.

### BRIEF DESCRIPTION OF THE DRAWINGS

FIG. 1 is an explanatory diagram for illustrating a form analysis example.

FIG. 2 is a block diagram illustrating a hardware configuration example of the analysis apparatus.

FIG. 3 is an explanatory diagram for illustrating an example of a document.

FIG. 4 is an explanatory diagram for illustrating an example of form definition information.

FIG. 5 is a block diagram for illustrating an example of a functional configuration of the analysis apparatus.

FIG. 6 is an explanatory diagram for illustrating a generation example of the cell arrangement feature.

FIG. 7 is an explanatory diagram for illustrating a generation example of a shared form group.

FIG. 8 is an explanatory diagram for illustrating an analysis example of the commonalities and the variabilities of the cells.

FIG. 9 is an explanatory diagram for illustrating an identification example of a false item name cell.

FIG. 10 is an explanatory diagram for illustrating an example of the form judgment condition element candidates.

FIG. 11 is an explanatory diagram for illustrating an identification example of the form judgment condition.

FIG. 12 is an explanatory diagram for illustrating an example of confirmation and correction of the form definition information

FIG. 13 is a flowchart for illustrating an example of an analysis processing procedure to be performed by the analysis apparatus.

FIG. 14 is a flowchart for illustrating a detailed processing procedure example of the document classification processing (Step S1302) illustrated in FIG. 13.

FIG. 15 is a flowchart for illustrating a detailed processing procedure example of the cell identification processing (Step S1304) illustrated in FIG. 13.

FIG. 16 is a flowchart for illustrating a detailed processing procedure example of the condition identification processing (Step S1306) illustrated in FIG. 13.

### DETAILED DESCRIPTION OF THE EMBODIMENT

<Form Analysis Example>

As described above, documents described in this example are, for example, spreadsheet format documents having layout attribute information, such as system input setting files, report files to be batch-output, and application log files, or spreadsheet format documents that do not have layout attribute information on, for example, formatting or rulers, like the CSV files.

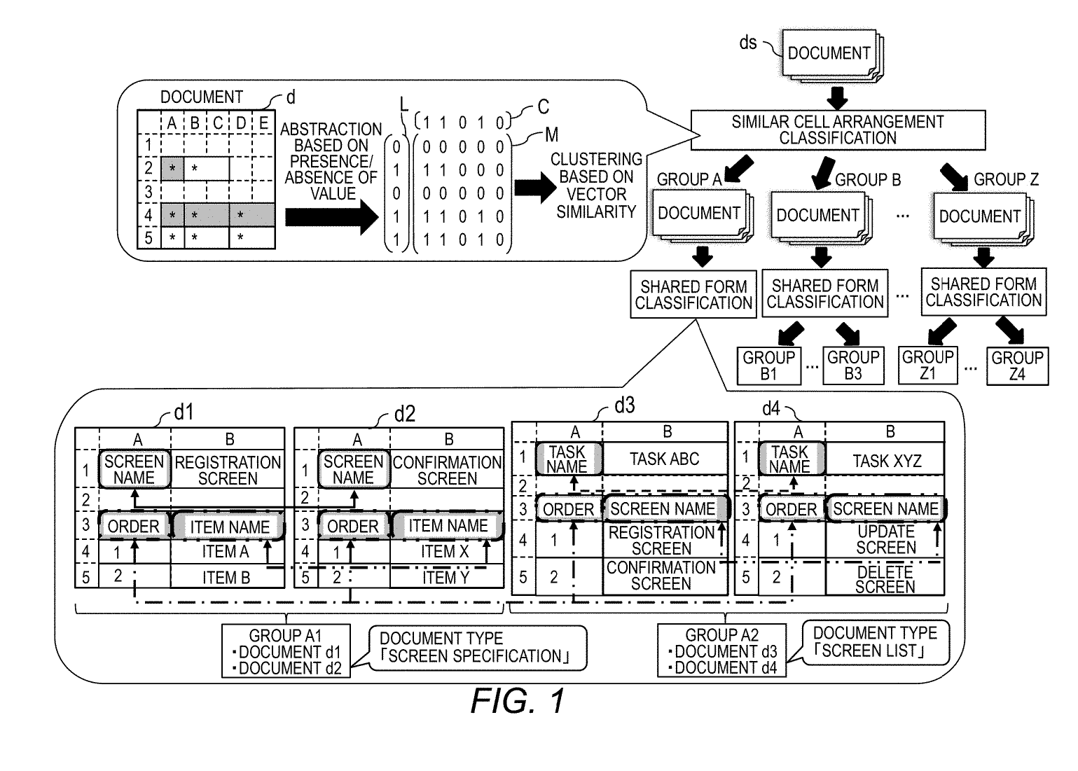

FIG. 1 is an explanatory diagram for illustrating a form analysis example. An analysis apparatus is configured to classify a document group ds into groups having a similar arrangement of cells in documents d (similar cell arrangement classification). Specifically, for example, the analysis apparatus determines a cell arrangement feature by abstracting the documents d based on the presence/absence of a value in the cells of the documents d. For example, the analysis apparatus generates a vector (non-empty cell matrix M) in which “1” is assigned to cells having a value and “0” is assigned to cells not having a value.

Further, the analysis apparatus generates, for the row numbers represented by a numeral, a vector (non-empty cell row vector L) in which “1” is assigned to cells of that row having a value and “0” is assigned to cells not having a value. Similarly, the analysis apparatus generates, for the column numbers represented by a capital letter of the alphabet, a vector (non-empty cell column vector C) in which “1” is assigned to cells of that column having a value and “0” is assigned to cells not having a value. The cell arrangement feature is a feature including a non-empty cell matrix, a non-empty cell row vector, and a non-empty cell column vector.

Then, the analysis apparatus clusters the document group ds based on a similarity of the non-empty cell matrix, the non-empty cell row vector, and the non-empty cell column vector, and classifies the document group ds into similar arrangement groups A, B, . . . , Z. As a result, documents having a similar cell arrangement can be grouped. This processing also enables spreadsheet format documents that do not have layout attribute information on formatting and rulers, such as a CSV file, to be classified by vectorizing the documents based on the presence/absence of a value in the cells.

Next, the analysis apparatus classifies the documents d in the similar arrangement groups A, B, . . . , Z classified by the similar cell arrangement classification into groups having a shared form (shared form groups) (shared form classification). Specifically, for example, the analysis apparatus identifies cells having the same position and the same value (shared cells) among the documents d in the similar arrangement groups A, B, . . . , Z. More specifically, for example, documents d1 to d4 are a document group ds belonging to the group A. The analysis apparatus identifies the cells in row 1, column A of documents d1 and d2 (screen name) as shared cells, the cells in row 1, column A of documents d3 and d4 (task name) as shared cells, the cells in row 3, column A of documents d1 to d4 (order) as shared cells, the cells in row 3, column B of documents d1 and d2 (item name as shared cells, and the cells in row 3, column B of documents d3 and d4 (screen name) as shared cells.

In other words, documents d1 and d2 are classified into a shared form group A1 in which the cells of row 1, column A (screen name), the cells of row 3, column A (order), and the cells of row 3, column B (item name) are shared cells. Documents d3 and d4 are classified into a shared form group A2 in which the cells of row 1, column A (task name), the cells of row 3, column A (order), and the cells of row 3, column B (screen name) are shared cells. In this way, documents d having a similar cell arrangement can be further grouped based on a commonality of the form among the documents d. As a result, the documents d can be classified without using a word dictionary of character strings in the cells.

### <Functional Configuration Example of Analysis Apparatus>

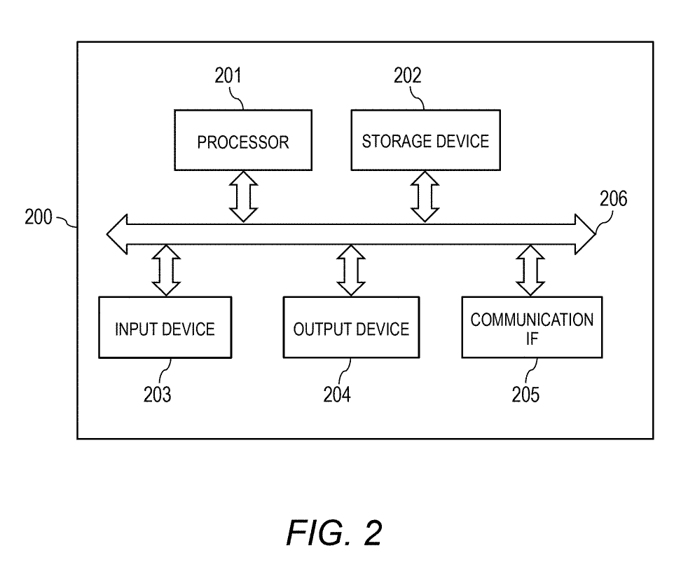

FIG. 2 is a block diagram illustrating a hardware configuration example of the analysis apparatus. The analysis apparatus 200 includes a processor 201, a storage device 202, an input device 203, an output device 204, and a communication interface (communication IF) 205. The processor 201, the storage device 202, the input device 203, the output device 204, and the communication IF 205 are connected to one another by a bus 206. The processor 201 controls the analysis apparatus 200. The storage device 202 serves as a work area of the processor 201. The storage device 202 is a recording medium which stores various programs and data. The storage device 202 can be, for example, a read-only memory (ROM), a random access memory (RAM), a hard disk drive (HDD), or a flash memory. The input device 203 inputs data. The input device 203 can be, for example, a keyboard, a mouse, a touch panel, a ten-key pad, or a scanner. The output device 204 outputs data. The output device 204 can be, for example, a display or a printer. The communication IF 205 couples to a network to transmit and receive data. Now, a description is given of an embodiment of this invention.

<Example of Documents d>

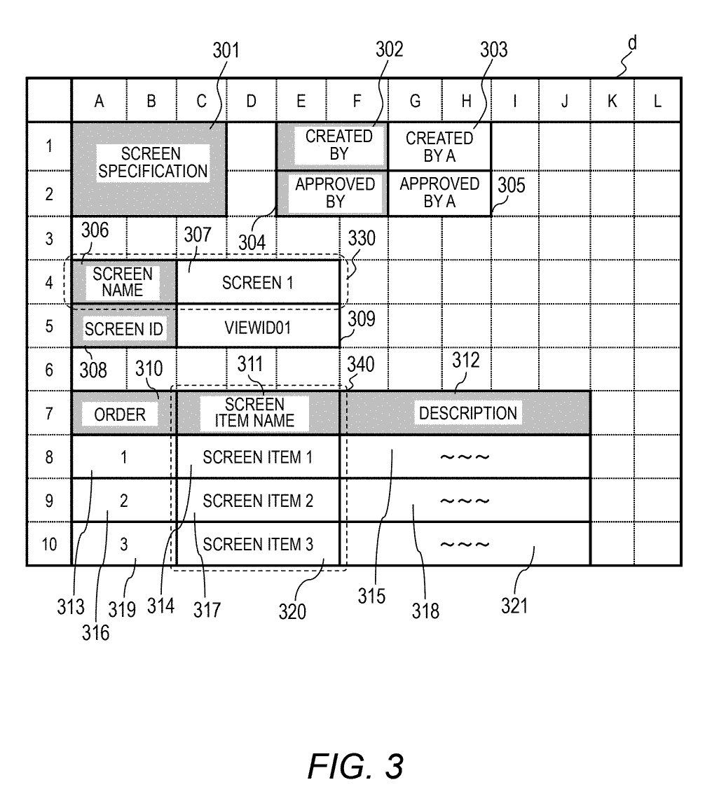

FIG. 3 is an explanatory diagram for illustrating an example of a document d. The document d is a system development document created in a spreadsheet format, for example. The document d has cell groups. The cells are constituent elements formed from position information on the row and column number, and a character string associated with that position information. The document d may be, for example, a file created by spreadsheet software, a CSV file in which the elements are separated by a delimiter like a comma or a blank space, or a text file.

The document d may include a merged cell formed by merging a plurality of cells. In this embodiment, it is assumed that, of the plurality of cells forming the merged cell, only the cell positioned at the upper left has a character string, and the other cells do not have a character string. For example, a cell 301 is a merged cell formed by merging six cells together, from rows 1 to 2 to columns A to C. However, the character string “screen specification” is included in only row 1, column A, and the other five cells do not have the character string. As another handling method, for example, the character string may be included in all of the cells forming the merged cell. However, the following description is based on the assumption that only the cell, positioned at the upper left has the character string.

The document d includes item name cells, item value cells, and non-item cells. The combination of an item name cell and an item value cell forms an “item”. The item name cells are cells having a character string representing the name of the item. Cells 302, 304, 306, 308, 310, 311, and 312 are item name cells. The item value cells are cells having a character string representing the value of the item. Cells 303, 305, 307, 309, and 313 to 321 are item value cells. The non-item cells are cells that have a character string, but are not classified as item name cells or item value cells. A cell 301 is a non-item cell.

The items are classified into single items or a table. A single item is an item in which one item value cell is associated with one item name cell. For example, an item 330, which is formed from the combination of the cell 306 (screen name), which is an item name cell, and the cell 307 (screen 1), which is an item value cell immediately to the right of that cell 306, is a single item.

A table is an item in which a plurality of item value cells are associated with one item name cell. For example, an item formed from the combination of the cell 311 (screen item name), which is an item name cell, and the cells 314 (screen item 1), 317 (screen item 2), and 320 (screen item 3), which are item value cells immediately below the cell 311, is a table 340.

### <Example of Form Definition Information>

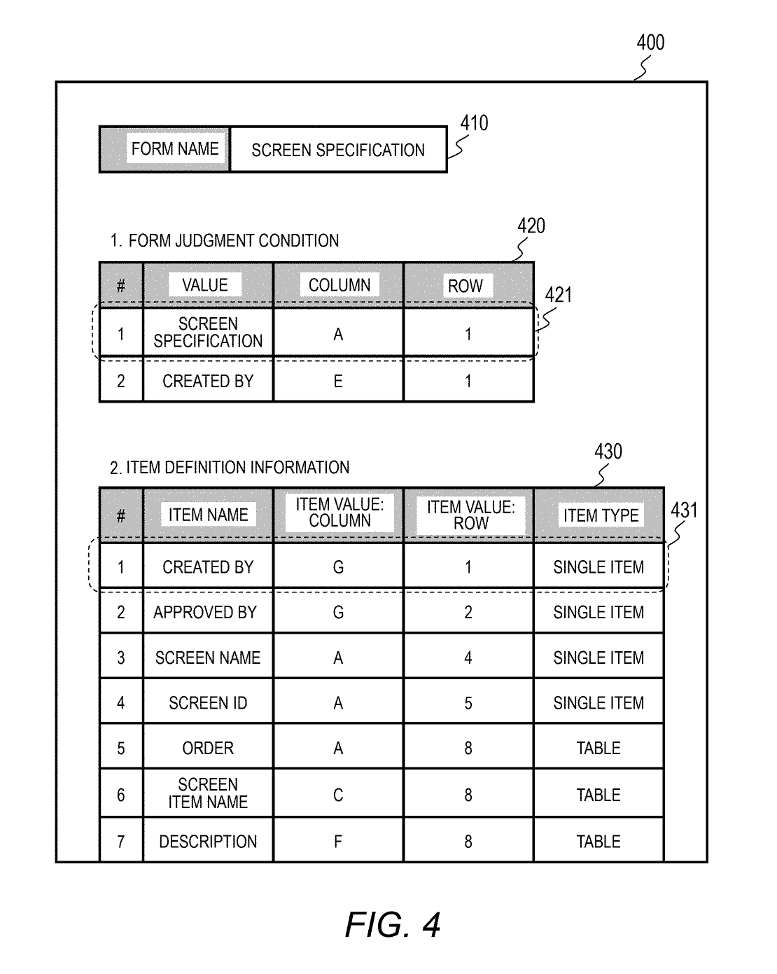

FIG. 4 is an explanatory diagram for illustrating an example of form definition information. Form definition information 400 is output information from an analysis apparatus 200. One piece of form definition information 400 is generated per one form of the documents d. The form definition information 400 includes a form name 410, a form judgment condition 420, and item definition information 430.

The form name 410 is a unique name for identifying the form. The form name 410 is not duplicated among different forms. For example, a number is assigned to the form name 410 in order of generation of the form definition information 400. A name input from the user is also assigned to the form name 410. A document label is also automatically assigned to the form name 410.

The form judgment condition 420 is a condition for judging the form of the documents d. The form definition information 400 includes one or more form judgment condition elements 421. The form judgment condition 420 is not duplicated among different forms. Each form judgment condition element 421 includes, as an entry, position information (row and column) and the character string (value) of the cells having position information and a character string shared by all of the documents d of the same form (hereinafter referred to as “completely shared cells”). For example, the form judgment condition element 421 represents a cell having the character string “screen specification” positioned in row 1, column A.

The item definition information 430 includes one or more item definitions 431. The item definition 431 is a piece of information defining an item that is included in the documents d. The item definition 431 includes a character string of an item name cell, position information (row and column) on an item value cell, and an item type. For example, the item definition 431 defines a single item formed from an item name cell having the character string “created by” and an item value cell positioned in row 1, column G. The position information on the item value cell when the item is a table is position information on the top item value cell that is the closest to the item name cell. For example, in the case of the table 340, as shown by entry #6, the item name is “screen item name”, the position information on the item value is row 8, column C, and the item type is “table”.

When the documents d satisfy the conditions of all of the form judgment condition elements 421 forming the form judgment condition 420, the documents d are associated with the form definition information 400. This enables the items included in the documents d to be automatically recognized based on the item definition information 430 in the form definition information 400.

### <Functional Configuration Example of Analysis Apparatus 200>

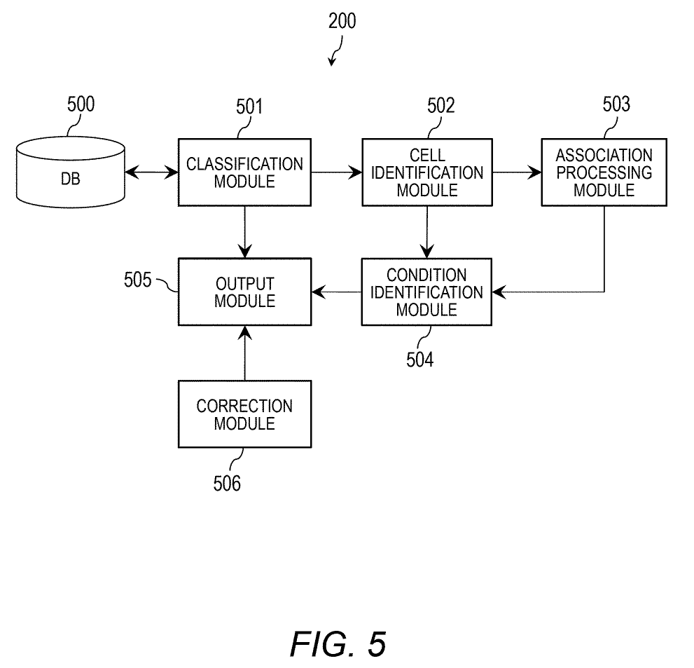

FIG. 5 is a block diagram for illustrating an example of a functional configuration of the analysis apparatus 200. The analysis apparatus 200 includes a classification module 501, a cell identification module 502, an association processing module 503, a condition identification module 504, an output module 505, and a correction module 506. Each module is implemented by causing a processor to execute a program stored in the storage device illustrated in FIG. 2. The analysis apparatus 200 is capable of accessing a database (DB) 500, which is arranged inside or outside the analysis apparatus 200. The DB 500 is configured to store the document group ds and the form definition information 400. An example of the documents included in the document group ds is the document illustrated in FIG. 3. Specifically, the DB 500 is implemented by the storage device 202 illustrated in FIG. 2, for example.

The classification module 501 is configured to analyze a similarity of the position information and the character strings of the cells among a plurality of documents, and to classify the document group ds into a plurality of groups. The classification module 501 includes two functions, namely, clustering based on cell arrangement feature analysis, and clustering based on shared cell feature analysis.

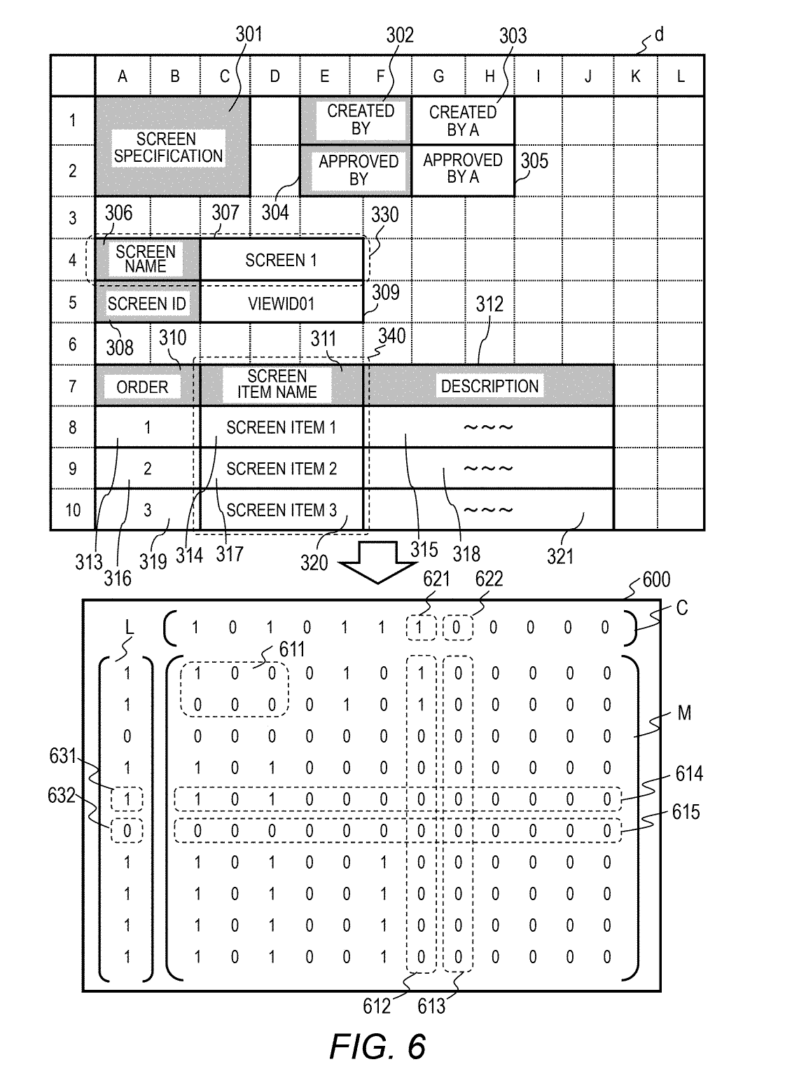

First, clustering based on cell arrangement feature analysis is described. The classification module 501 analyzes a cell arrangement feature of each document by performing clustering based on cell arrangement feature analysis. As described with reference to FIG. 1, the cell arrangement feature is a feature relating to position information in a document of, among the cell groups in the document, a cell having a character string (hereinafter referred to as “non-empty cell”). The classification module 501 stores the cell arrangement feature in the DB 500. A generation example of the cell arrangement feature is now described with reference to FIG. 6.

FIG. 6 is an explanatory diagram for illustrating a generation example of the cell arrangement feature. A cell arrangement feature 600 is a feature including a non-empty cell matrix M, a non-empty cell column vector C, and a non-empty cell row vector L.

The non-empty cell matrix M is data in which all or a part of the cells in a document d have been abstracted based on the presence/absence of a character string in each cell by performing clustering based on cell arrangement feature analysis. The elements forming the matrix are, for example, non-empty cells represented by the number “1”, and cells that do not have a character string (hereinafter referred to as “empty cells”) represented by the number “0”. For example, in the cell 301, which is a non-item cell, only the cell at row 1, column A is a non-empty cell having the character string “screen specification”, and the other five cells are empty cells. The classification module 501 converts the cell 301, which is a non-item cell, into an element group 611 of the non-empty cell matrix M by performing clustering based on cell arrangement feature analysis.

The non-empty cell column vector C is data in which all or a part of the columns of a document d have been abstracted based on the presence/absence of a non-empty cell in that column by performing clustering based on cell arrangement feature analysis. The elements forming the column vector are, for example, columns including a non-empty cell, which are represented by the number “1”, and columns not including a non-empty cell, which are represented by the number “0”. For example, a column G in the document d corresponds to a column 612 that is the seventh column from the left in a non-empty cell matrix M. The column 612 includes non-empty cells 303 and 305. The classification module 501 sets an element 621 of the non-empty cell column vector C to “1” by performing clustering based on cell arrangement feature analysis. A column 613 does not have a non-empty cell. The classification module 501 sets an element 622 of the non-empty cell column vector C to “0” by performing clustering based on cell arrangement feature analysis.

The non-empty cell row vector L is data in which all or a part of the rows of a document d have been abstracted based on the presence/absence of a non-empty cell in that row by performing clustering based on cell arrangement feature analysis. The elements forming the row vector are, for example, rows including a non-empty cell, which are represented by the number “1”, and rows not including a non-empty cell, which are represented by the number “0”. For example, a row 5 in the document d corresponds to a row 614 that is the fifth row from the top in the non-empty cell matrix M. The row 614 includes non-empty cells 308 and 309. The classification module 501 sets an element 631 of the non-empty cell row vector L to “1” by performing clustering based on cell arrangement feature analysis. A row 615 does not have a non-empty cell. The classification module 501 sets an element 632 of the non-empty cell row vector L to “0” by performing clustering based on cell arrangement feature analysis.

Referring back to FIG. 5, the classification module 501 also clusters the document group ds based on the similarity of the cell arrangement feature among the documents d by performing clustering based on cell arrangement feature analysis, and generates one or more similar arrangement groups, which are groupings of documents having a similar cell arrangement feature. Specifically, for example, the classification module 501 calculates a distance of the cell arrangement feature among the documents d. More specifically, for example, the classification module 501 calculates a Jaccard distance or a cosine distance of the non-empty cell column vector C (or the non-empty cell row vector L) between two given documents d. The classification module 501 judges, for example, when the calculated distance is equal to or more than a threshold, that the two documents d are similar. The threshold may be arbitrarily set from the input device 203 by the user. The classification module 501 may also use aggregative hierarchical clustering based on Ward's method when clustering the document group ds.

The classification module 501 confers, when clustering based on cell arrangement feature analysis has been performed, a group ID for uniquely identifying a similar arrangement group to the documents belonging to that similar arrangement group. More specifically, for example, the classification module 501 associates a document ID for identifying a document and a group ID of the similar arrangement group to which that document belongs. The classification module 501 stores information associating the document ID and the group ID in the DB 500.

Clustering based on shared cell feature analysis is now described. Clustering based on shared cell feature analysis is performed by analyzing a shared cell feature of each document in every similar arrangement group generated by clustering based on cell arrangement feature analysis. The shared cell feature is a feature relating to cells in which position information and a character string match (hereinafter referred to as “shared cells in the similar arrangement group”) among the documents belonging to the same similar arrangement group.

The shared cell feature is represented by, for example, a vector in which the numbers “1, 0” representing the presence/absence of a shared cell in the similar arrangement group in each document are used as elements. The classification module 501 analyzes the shared cell feature of all the documents of all the similar arrangement groups by performing clustering based on shared cell feature analysis. The classification module 501 stores the shared cell feature of each document in the DB 500.

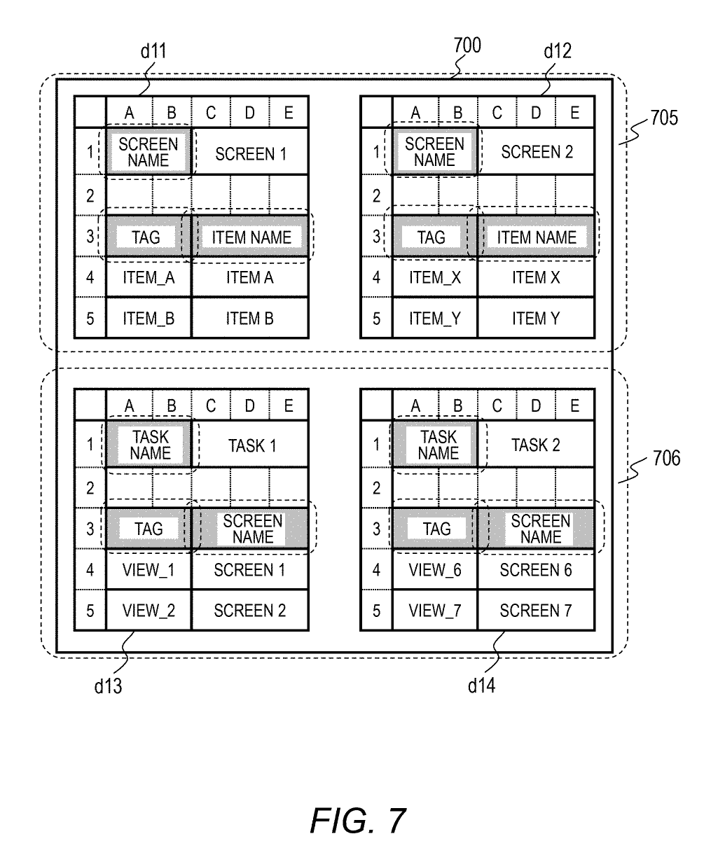

The classification module 501 also generates one or more shared form groups, which are groupings of documents having a similar shared cell feature, by again clustering, for all the similar arrangement groups, the documents based on the similarity of the shared cell feature among the documents by performing clustering based on shared cell feature analysis. A generation example of a shared form group is described with reference to FIG. 7.

FIG. 7 is an explanatory diagram for illustrating a generation example of a shared form group. Documents d11 to d14 have a shared non-empty cell column vector C (1, 0, 1, 0, 0), which is a cell arrangement feature, and a shared non-empty cell row vector L (1, 0, 1, 1, 1). In the documents d11 to d14, when the non-empty cell column vector C and the non-empty cell row vector L completely match, the non-empty cell matrix M also completely matches. Therefore, the documents d11 to d14 are a similar document group ds. The classification module 501 sets a similar arrangement group 700 to which the documents d11 to d14 belong by performing clustering based on cell arrangement feature analysis.

Next, the classification module 501 analyzes the shared cells in the similar arrangement group by performing clustering based on shared cell feature analysis on the similar arrangement group 700. Specifically, for example, the classification module 501 identifies, in the documents d11 to d14, a cell “tag” positioned in row 3, column A as a shared cell in the similar arrangement group. The classification module 501 also identifies, in the documents d11 and d12, a cell “screen name” positioned in row 1, column A and a cell “item name” positioned in row 3, column C as shared cells in the similar arrangement group. The classification module 501 also identifies, in the documents d13 and d14, a cell “task name” positioned in row 1, column A and a cell “screen name” positioned in row 3, column C as shared cells in the similar arrangement group.

The shared cell feature in the similar arrangement group 700 is now described with reference to FIG. 7. For example, the shared cell feature is represented by a vector in which the numbers “1, 0” representing the presence/absence of each shared cell in the similar arrangement group are used as elements. The order of the shared cells in the similar arrangement group is row 3, column A (tag), row 1, column A (screen name), row 3, column C (item name), row 1, column A (task name), and row 3, column C (screen name) (the content in the parentheses represents the character string in the cell). In this case, the shared cell feature of the documents d11 and d12 is (1, 1, 1, 0, 0). Similarly, the shared cell feature of the documents d13 and d14 is (1, 0, 0, 1, 1).

Specifically, for example, the classification module 501 calculates, similarly to the clustering based on cell arrangement feature analysis, a distance of the shared cell feature among the documents d. More specifically, for example, the classification module 501 calculates a Jaccard distance or a cosine distance of the shared cell feature between two given documents d. The classification module 501 judges, for example, when the calculated distance is equal to or more than a threshold, that the two documents d are similar. The threshold may be arbitrarily set from the input device 203 by the user. The classification module 501 may also use, when clustering the document group ds, aggregative hierarchical clustering based on Ward's method.

In this example, the shared cell feature of each of the documents d11 and d12 completely matches, and hence the calculated distance is equal to or more than the threshold. Therefore, the documents d11 and d12 belong to the same shared form group. The shared cell feature of each of the documents d13 and d14 completely matches, and hence the calculated distance is equal to or more than the threshold. Therefore, the documents d13 and d14 belong to the same shared form group. However, the shared cell feature of each of the documents d11 and d13, the shared cell feature of each of the documents d11 and d14, the shared cell feature of each of the documents d12 and d13, and the shared cell feature of each of the documents d12 and d14 are all dissimilar. As a result of performing clustering based on shared cell feature analysis on the documents d11 to d14, the similar arrangement group 700 is classified by the classification module 501 into a shared form group 705 to which the documents d11 and d12 belong, and a shared form group 706 to which the documents d13 and d14 belong.

The classification module 501 confers, when clustering based on shared cell feature analysis has been performed, a group ID for uniquely identifying a shared form group to the documents belonging to that shared form group. More specifically, for example, the classification module 501 associates a document ID for identifying a document and a group ID of the shared form group to which that document belongs. The classification module 501 stores information associating the document ID and the group ID in the DB 500.

The cell identification module 502 is configured to identity, for each shared form group, the item name cells and the item value cells by analyzing the commonalities and the variabilities of the cells. Specifically, for example, the cell identification module 502 identities cells in which the position information and the character string match among all of the documents d belonging to the same shared form group (hereinafter referred to as “shared cells in the shared form group”). The shared cells in the shared form group become item name cell candidates. The cell identification module 502 also identifies cells in which the position information matches but the character string is different as variable cells in the shared form group. The variable cells in the shared form group become item value cell candidates.

It is not necessary for the shared cells in the shared form group to be cells having matching position information and matching character strings among all the documents d, but rather the shared cells in the shared form group may be cells having position information and character strings that are matching in a part of the documents in a ratio equal to or more than a certain threshold. The threshold may be arbitrarily set. The cell identification module 502 may also identifies the shared cells in the shared for a group by utilizing the information obtained when identifying the shared cells in the similar arrangement group. In the shared form group, cells that are empty cells in a ratio of the documents equal to or more than a threshold may be set so as to not be handled as shared cells in the shared form group or as variable cells in the shared form group. That threshold may be arbitrarily set.

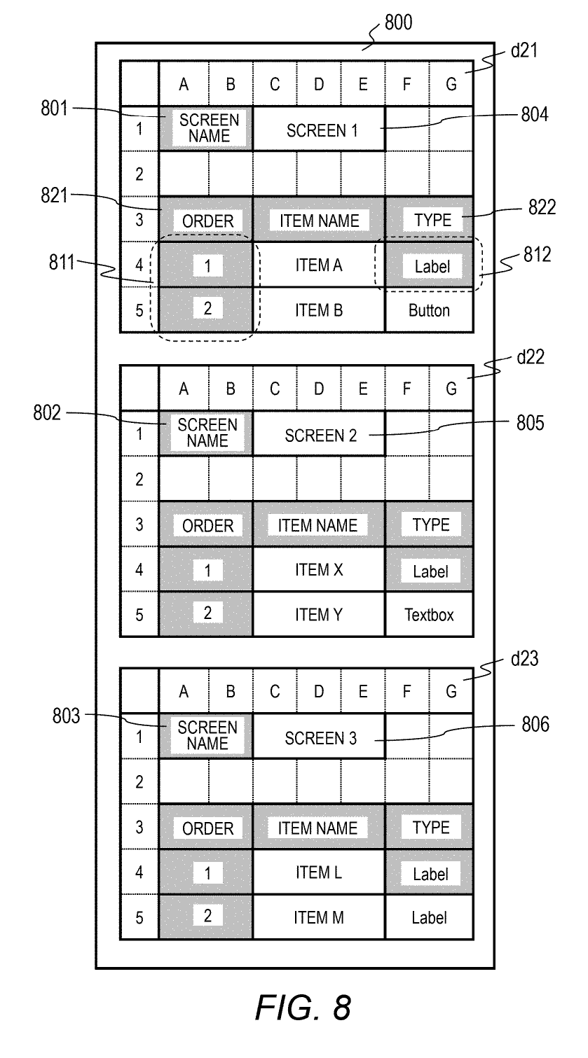

FIG. 8 is an explanatory diagram for illustrating an analysis example of the commonalities and the variabilities of the cells. A shared form group 800 includes documents d21 to d23. The non-empty cells having a colored background represent shared cells in the shared form group, and the non-empty cells having a colorless background represent variable cells in the shared form group. For example, cells 801 to 803 respectively positioned in row 1, column A of the documents d21 to d23 have the same character string, namely, “screen name”, and hence those cells are shared cells in the shared form group. Cells 804 to 806 positioned in row 1, column C each have a different character string, namely, “screen 1”, “screen 2”, and “screen 3”, respectively, and hence those cells are variable cells in the shared form group.

The cell identification module 502 identifies the shared cells in the shared form group as item name cells and the variable cells in the shared form group as item value cells. However, there are cells, like cells 811 and 812, called “false item name cells”, which despite being shared cells in the shared form group, are in fact item value cells. Therefore, the cell identification module 502 identifies in advance the false item name cells.

For example, a cell group 811 is formed from item value cells corresponding to an item name cell 821 “order”, but character strings corresponding to an “order” are denoted as numbers, and hence the cell group 811 has the character strings “1” and “2” that are shared by the documents d21 to d23. Therefore, the cell group 811 is a false item name cell. A cell 812 is an item value cell corresponding to an item name cell 822 “type”, but just happens to have a character string “label” that is shared by the documents d21 to d23. Therefore, the cell 812 is a false item name cell. In this way, the cell identification module 502 identifies the false item name cells included in a table by utilizing the nature of a table starting from an item name cell and item value cell(s) continuing immediately below the item name cell (table area identification processing).

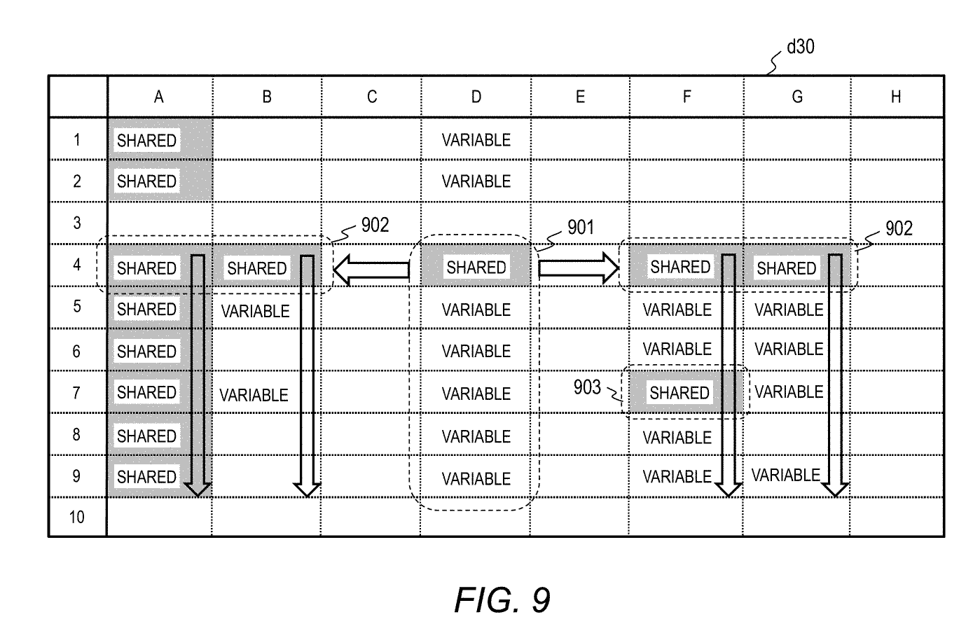

FIG. 9 is an explanatory diagram for illustrating an identification example of a false item name cell. A document d30 is a spreadsheet visualizing arrangement information on the shared cells in the shared form group and the variable cells in the shared form group of the shared form group. The cell identification module 502 executes table area identification processing based on the following procedure in order to identify the false item name cells.

Specifically, for example, the cell identification module 502 identifies, for each shared cell group in the shared form group in the document d30, the variable cells in the shared form groups that continue immediately below the shared cells in the shared form group. The cell identification module 502 identifies a longest column 901 that has the most variable cells in the shared form groups that start from and continue immediately below the shared cells in the shared form group.

Next, the cell identification module 502 identifies, as an item name cell, another shared cell(s) 902 in the shared form group that is/are on the same row as the top shared cell in the shared form group of the longest column 901. The cell identification module 502 identifies, among the cells immediately below the shared cell(s) 902 in the shared form group, the same number of cells as the variable cells in the shared form group of the longest column 901 to be item value cells. At that point, when there is a shared cell 903 in the shared form group among the cells immediately below the shared cell(s) 902 in the shared form group, that cell is identified as a false item name cell. In this case, the shared cell 903 in the shared form group is an item value cell and a false item name cell.

The cell groups identified as item name cells and item value cells are referred to as table areas. The cell identification module 502 identifies the remaining shared cells in the shared form group that are not included in the table areas as item name cells. Similarly, the cell identification module 502 identifies the remaining variable cells in the shared form group that are not included in the table areas as item value cells.

The cell identification module 502 associates identification information on the item name cells with a cell ID of each shared cell 902 in the shared form group identified as an item name cell, associates identification information on the item value cells with a cell ID of each variable cell in the shared form group identified as an item value cell, and associates identification information on the false item name cells with a cell ID of each shared cell 903 in the shared form group identified as a false item name cell. The cell identification module 502 stores the information associating the cell IDs and the identification information in the DB 500.

The association processing module 503 is configured to associate the item name cells and the item value cells based on a positional relation between the item name cells and the item value cells. The association processing module 503 may also associate the item name cells and the item value cells based on a cell size of the item name cells and the item value cells. Specifically, for example, the association processing module 503 confers a penalty value to the item name cells and the item value cells on which the association processing is to be performed by using the penalty rules described in JP 2011-248609 A.

For example, as illustrated by the cells 302 and 303 of FIG. 3, the item value cell 303 is to the right of the corresponding item name cell 302. Therefore, the association processing module 503 confers a penalty value on the item name cells and the item value cells on which association processing is to be performed when the item name cell is to the left of the item value cell.

As illustrated by the cells 310 and 313 of FIG. 3, the item value cell 313 is below the corresponding item name cell 312. Therefore, the association processing module 503 confers a penalty value on the item name cells and the item value cells on which association processing is to be performed when the item name cell is above the item value cell.

The item value cells are close to the corresponding item name cells. Therefore, the association processing module 503 confers a penalty value on the item name cells and item value cells on which association processing is to be performed in proportion to the length of the distance between the item name cells and the item value cells. Even in a case where the length is long, when there is another item value cell associated with the item name cell among the item name cells and the item value cells on which association processing is to be performed, the association processing module 503 does not confer a penalty value on the cells on which association processing is to be performed, because those cells are table candidates.

Next, the association processing module 503 associates, for example, when a sum of the penalty values is equal to or less than a threshold, the item name cells and the item value cells on which association processing is to be performed. When only one item value cell is associated with the item name cell, the combination of that item name cell and that item value cell is a single item. When a plurality of item value cells are associated with the item name cell, the combination of that item name cell and those item value cells is a table.

The association processing module 503 creates an entry of the item definition information 430 in the form definition information 400 for the pair of the associated item name cell and item value cell. Specifically, for example, the association processing module 503 stores the character string of the item name cell in an item name field, stores position information (column number and row number) on the item value cell in an “item value: column” field and “item value: row” field, and stores the item type (i.e., single item or table) in an item type field.

The association processing module 503 identifies an item name cell that is not associated with even one item value cell as a non-item cell, associates a cell ID of that non-item cell, an ID indicating that the cell is a non-item cell, and the group ID of the shared form group with one another, and stores the associated information in the DB 500.

The condition identification module 504 is configured to identify the form judgment condition 420 for judging the document form. The condition identification module 504 identifies, for each shared form group, the completely shared cells having matching position information and the matching character string among all of the documents d belonging to the same shared form group as form judgment condition element candidates. The condition identification module 504 associates the cell ID of each form judgment condition element candidate with the group ID of the shared form group, and stores the associated information in the DB 500. When analyzing the completely shared cells, the condition identification module 504 may also utilize the information associated when identifying the shared cells in the similar arrangement group or the shared cells in the shared form group.

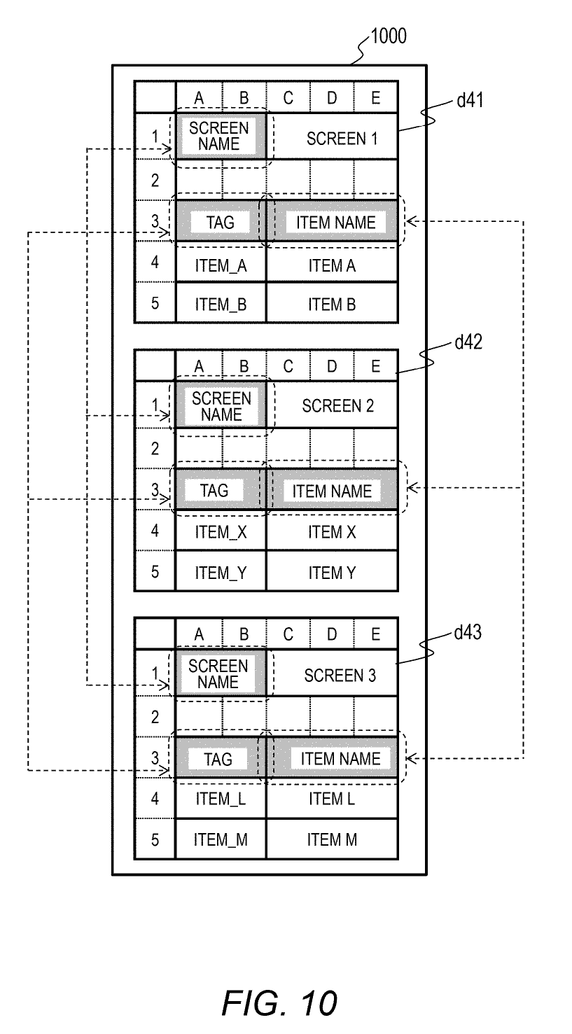

FIG. 10 is an explanatory diagram for illustrating an example of the form judgment condition element candidates. A shared form group 1000 includes documents d41 to d43. The condition identification module 504 identifies the completely shared cells “row 1, column A: screen name”, “row 3, column A: tag”, and “row 3, column C: item name” shared by the documents d41 to d43 as the form judgment condition element candidates of the shared form group 1000. The condition identification module 504 also identifies a unique form judgment condition among the shared form groups by using the form judgment condition element candidates.

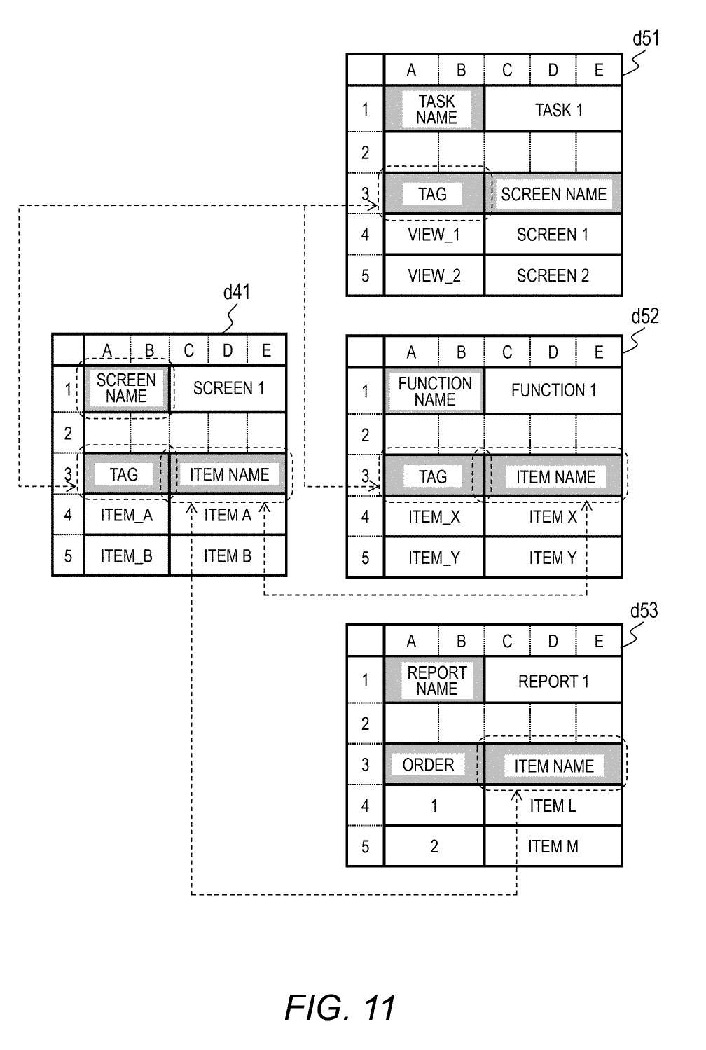

FIG. 11 is an explanatory diagram for illustrating an identification example of the form judgment condition. The document d41 and documents d51 to d53 are the documents d that belong to different shared form groups. As described above, the form judgment condition element candidates of the shared form group 1000 to which the document d41 belongs are “row 1, column A: screen name”, “row 3, column A: tag”, and “row 3, column C: item name”. However, “row 3, column A: tag” is an element included in the documents d51 and d52, and “row 3, column C: item name” is an element included in the documents d52 and d53.

Therefore, the optimum form judgment condition element candidate as a unique form judgment condition between the two shared form groups is “row 1, column A: screen name” that is not included in the documents d51 to d53. In this example, one form judgment condition element candidate is used to form the form judgment condition, but combinations of a plurality of form judgment condition element candidates may be used to form the form judgment condition.

For example, when the character string of the cell at row 1, column A in the document d51 is “screen name”, “row 1, column A: screen name” cannot serve by itself as the form judgment condition of the shared form group 1000. On the other hand, a combination of “row 3, column A: tag” and “row 3, column C: item name” of the documents d41, d52, and d53 may be used as a form judgment condition of the shared form group 1000.

The condition identification module 504 adds the minimum number of form judgment condition element candidates for forming the form judgment condition as an entry of the form judgment condition 420 of the form definition information 400. The condition identification module 504 also associates that entry with the group ID of the shared form group, and stores the associated information in the DB 500. The condition identification module 504 may also add all of the form judgment condition element candidates as entries in the form judgment condition 420 of the form definition information 400.

The output module 505 reads, for each shared form group, the form definition information 400 and the documents d belonging to the shared form groups from the DB 500. The output module 505 also displays on a display screen of a display device, which is an example of the output device 204, the read form definition information 400 and documents d in a manner that allows the user to confirm the correctness of the form definition information 400. The output module 505 may also output the form definition information 400 and the documents d to an external apparatus from the communication IF 205.

The correction module 506 is configured to receive from the input device 203 a correction command from the user for the content displayed on the display screen.

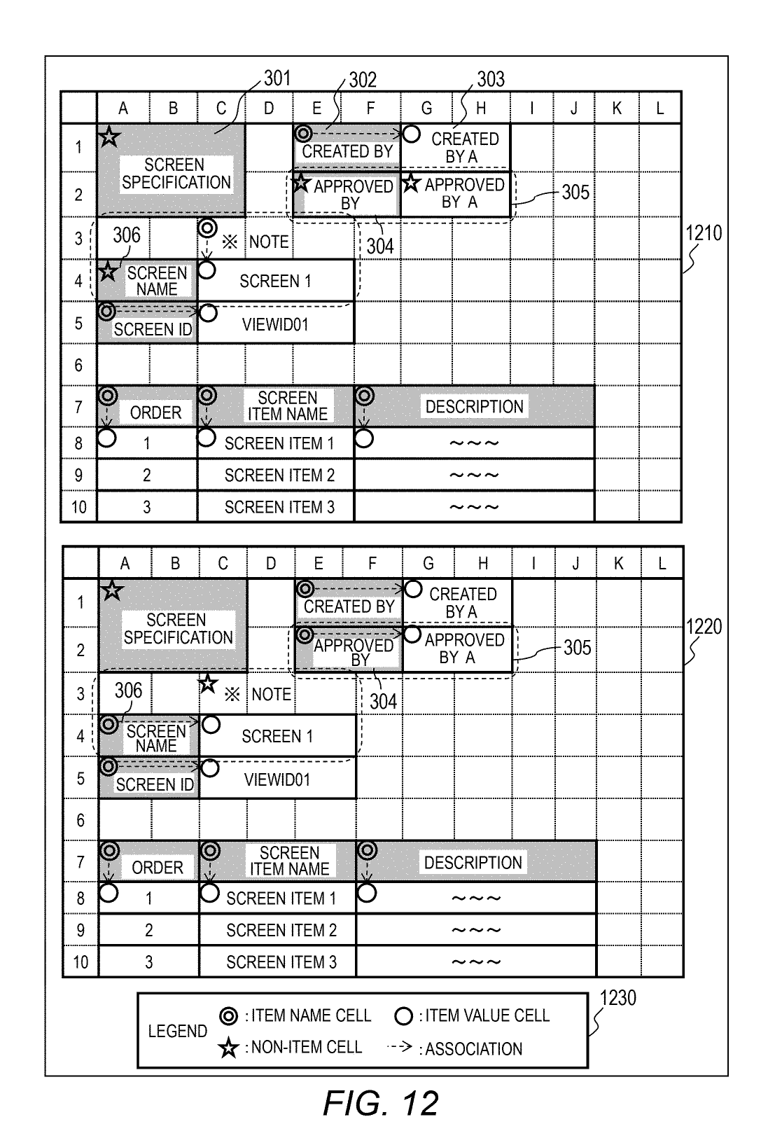

FIG. 12 is an explanatory diagram for illustrating an example of confirmation and correction of the form definition information. A form definition information confirmation screen 1210 is a screen example in which pre-correction form definition information 400 is reflected in the document d. A form definition information confirmation screen 1220 is a screen example in which corrected form definition information 400 is reflected in the document d. A legend 1230 is an illustration of an example of a visualization method for the form definition information on the form definition information confirmation screens 1210 and 1220.

For example, on the form definition information confirmation screen 1210, the cell 301 (screen specification) at row 1, column A is a non-item cell, the cell 302 (created by) at row 1, column E is an item name cell, and the cell 303 (created by A) at row 1, column G is an item value cell. The cell 302 (created by) at row 1, column E and the cell 303 (created by A) at row 1, column G are associated with each other as a corresponding item name cell and item value cell.

On the form definition information confirmation screen 1210, the cell 304 (created by) at row 2, column E and the cell 305 (created by A) at row 2, column G are non-item cells. Through superimposition of the actual document d and the form definition information 400, the user can easily identify that there is an error in the form definition information 400. Therefore, the correction module 506 corrects the form definition information 400 in response to a correction command transmitted to the correction module 506 from the input device 203.

On the form definition information confirmation screen 1220, the correction command from the user has been reflected, and the cell 304 (created by) at row 2, column E and the cell 305 (created by A) at row 2, column G have been corrected as an associated item name cell and item value cell. The cell (note) at row 3, column C and the cell 306 (screen name) at row 4, column A have also been corrected in the same manner.

The file format in which the form definition information 400 is to be written is not limited in the analysis apparatus 200. The form definition information 400 may be output in a spreadsheet format that is easy for the user to directly correct, or may be output to match an input format capable of using the form definition information 400, like in JP 2013-257852 A.

### <Example of Analysis Processing Procedure to be Performed by Analysis Apparatus 200>

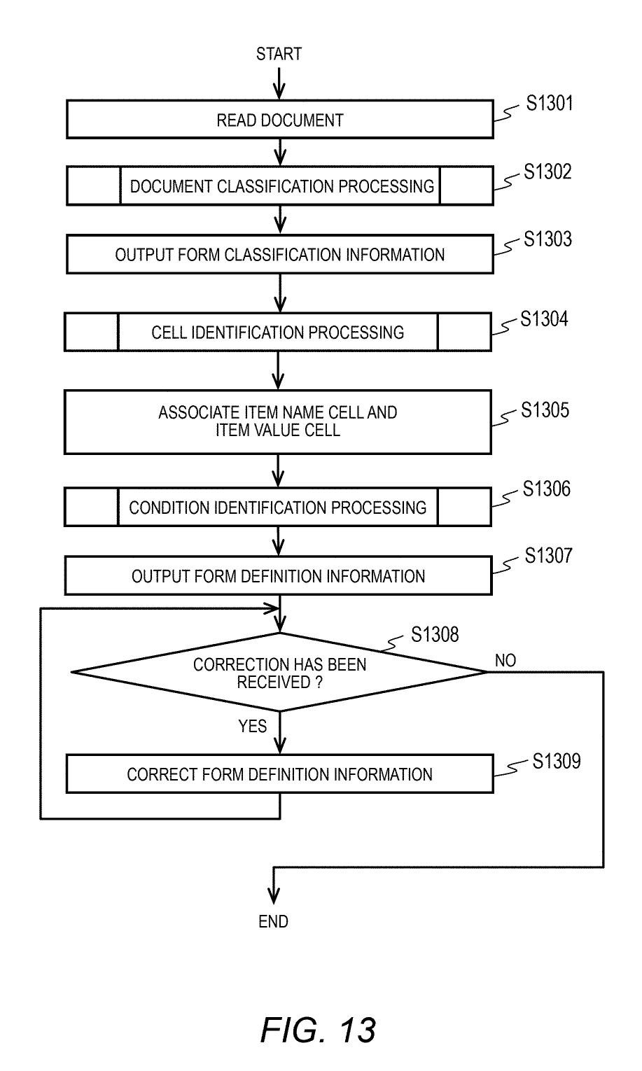

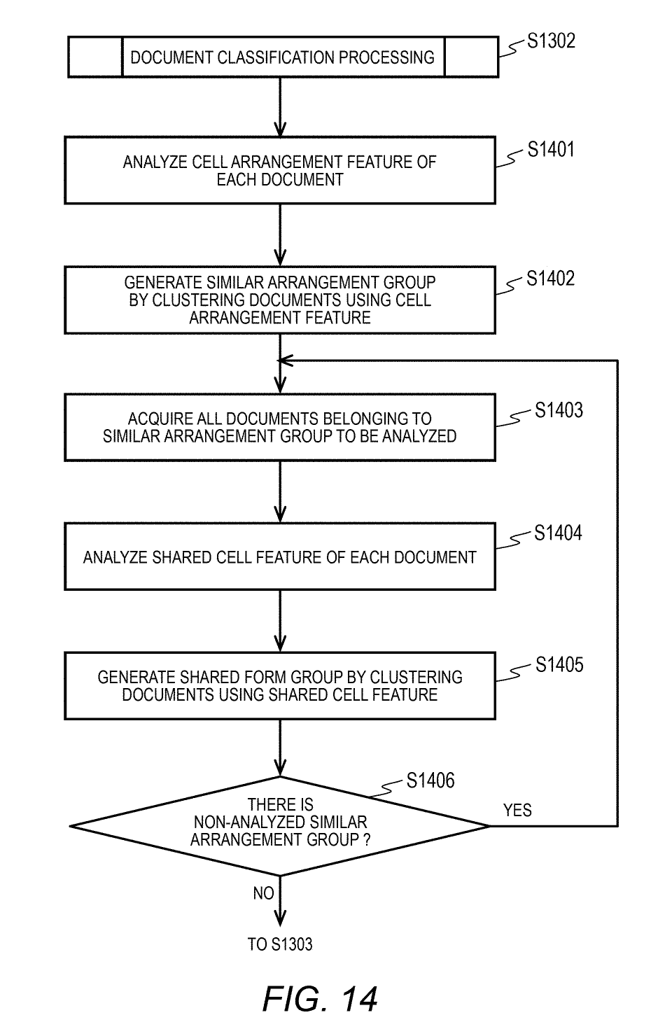

FIG. 13 is a flowchart for illustrating an example of an analysis processing procedure to be performed by the analysis apparatus 200. First, the analysis apparatus 200 reads the document group ds from the DB 500 (Step S1301). Next, the analysis apparatus 200 executes, by the classification module 501, document classification processing for classifying the read document group ds (Step S1302). Based on the document classification processing (Step S1302), the document group ds is classified into one or more shared form groups as illustrated in FIG. 1 and FIG. 7. The details of the document classification processing (Step S1302) are described later with reference to FIG. 14.

Then, the analysis apparatus 200 outputs form classification information, which is the classification result of the document classification processing (Step S1302), from the output module 505 (Step S1303). This allows the user to confirm the form classification information.

Next, the analysis apparatus 200 executes cell identification processing by the cell identification module 502 (Step S1304). Based on the cell identification processing (Step S1304), the cells in the documents d of each shared form group can be identified as being an item name cell, an item value cell, and a false item name cell as illustrated in FIG. 8 and FIG. 9.

Next, the analysis apparatus 200 associates an item name cell and an item value cell by the association processing module 503 (Step S1305). As a result, a single item and a table are obtained.

Next, the analysis apparatus 200 executes condition identification processing by the condition identification module 504 (Step S1306). Based on the condition identification processing (Step S1306), the form judgment condition 420 is identified as illustrated in FIG. 10 and FIG. 11.

Then, the analysis apparatus 200 outputs form definition information from the output module 505 (Step S1307). When correction content has been received from the input device 203 (Step S1308: Yes), the analysis apparatus 200 corrects the documents by the correction module 506 in accordance with the correction content as illustrated in FIG. 12 (Step S1309), and returns the processing to Step S1308. When correction content has not been received from the input device 203 (Step S1308: No), the analysis apparatus 200 ends the analysis processing.

### <Document Classification Processing (Step S1302)>

FIG. 14 is a flowchart for illustrating a detailed processing procedure example of the document classification processing (Step S1302) illustrated in FIG. 13. The analysis apparatus 200 analyzes the cell arrangement feature for each document as illustrated in FIG. 1 and FIG. 6 (Step S1401). Next, the analysis apparatus 200 clusters the documents based on the similarity of the cell arrangement feature among the documents as illustrated in FIG. 1, and generates one or more similar arrangement groups (Step S1402).

Next, the analysis apparatus 200 acquires from the DB 500 all the documents d belonging to, of the similar arrangement groups, the similar arrangement group to be analyzed (Step S1403). The analysis apparatus 200 then analyzes the shared cell feature among the documents d in the similar arrangement group to be analyzed (Step S1404). The analysis apparatus 200 then clusters the documents based on the similarity of the shared cell feature among the analyzed documents d, and forms one or more shared form groups to be analyzed (Step S1405).

Then, the analysis apparatus 200 judges whether or not there is a non-analyzed similar arrangement group (Step S1406). When there is a non-analyzed similar arrangement group (Step S1406: Yes), the analysis apparatus 200 returns the processing to Step S1403. On the other hand, when there is no non-analyzed similar arrangement group (Step S1406: No), the analysis apparatus 200 ends the document classification processing (Step S1302), and advances the processing to Step S1303.

### <Cell Identification Processing (Step S1304)>

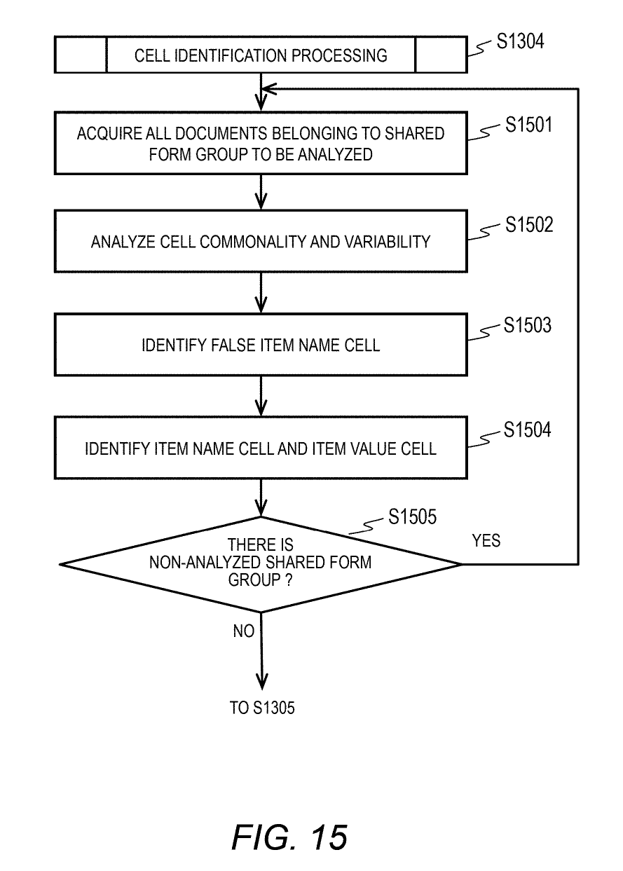

FIG. 15 is a flowchart for illustrating a detailed processing procedure example of the cell identification processing (Step S1304) illustrated in FIG. 13. The analysis apparatus 200 acquires from the DB 500 all of the documents belonging to, of the shared form groups, the shared form group to be analyzed (Step S1501). Next, the analysis apparatus 200 analyzes cell commonality and variability, and identifies the shared cells in the shared form group and the variable cells in the shared form group (Step S1502).

Next, the analysis apparatus 200 identifies, as a table area, the item name cells and the item value cells also including a false item name cell that are included in the table based on table area identification processing (Step S1503). The analysis apparatus 200 then identifies, as item name cells, the shared cells in the shared form group that were not included in the table area identified in Step S1503, and as item value cells, the variable cells in the shared form group that were not included in the table area identified in Step S1503 (Step S1504).

Then, the analysis apparatus 200 judges whether or not there is a non-analyzed shared form group (Step S1505). When there is a non-analyzed shared form group (Step S1505: Yes), the analysis apparatus 200 returns the processing to Step S1501. On the other hand, when there is no non-analyzed shared form group (Step S1505: No), the analysis apparatus 200 ends the cell identification processing (Step S1304), and advances the processing to Step S1305.

### <Condition Identification Processing (Step S1306)>

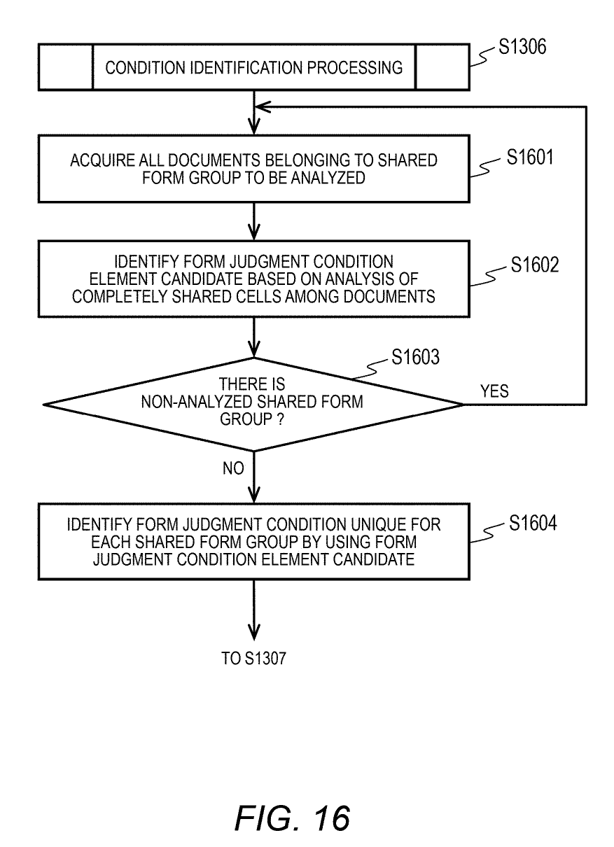

FIG. 16 is a flowchart for illustrating a detailed processing procedure example of the condition identification processing (Step S1306) illustrated in FIG. 13. The analysis apparatus 200 acquires from the DB 500 all of the documents belonging to, of the shared form groups, the shared form group to be analyzed (Step S1601). Next, the analysis apparatus 200 analyzes the completely shared cells among the documents, and identifies a form judgment condition element candidate (Step S1602).

Next, the analysis apparatus 200 judges whether or not there is a non-analyzed shared form group (Step S1603). When there is a non-analyzed shared form group (Step S1603: Yes), the analysis apparatus 200 returns the processing to Step S1601. On the other hand, when there is no non-analyzed shared form group (Step S1603: No), the analysis apparatus 200 acquires from the DB 500 the form judgment condition element candidate of each shared form group, and identifies the form judgment condition unique for each shared form group by combining the acquired form judgment condition element candidates (Step S1604). The analysis apparatus 200 then ends the condition identification processing (Step S1306), and advances the processing to Step S1307.

In the embodiment described above, the analysis apparatus 200 may be configured to generate a template of the documents d for each shared form group by referring to the form definition information 400. As a result, the user can use the template when newly creating the documents d, which enables the efficiency of the document creation processing to be improved.

In this way, the analysis apparatus 200 according to this embodiment is configured to classify, based on a commonality relating to a character string included in the cells of each document among the documents d in a document group ds in a spreadsheet format and to the position of the cells including the character string, the documents d in the document group ds into one or more shared form groups having a shared form, and to output the classification result. As a result, a large variety and a large amount of documents can be classified for each form without using added input, for example, layout attribute information on the documents d or a word dictionary.

The analysis apparatus 200 may also be configured to classify the documents d in the document group ds into one or more similar arrangement groups for which, of cell groups in each document d, the arrangement of non-empty cells, which are cells including a character string, and the empty cells, which are cells not including a character string, is the same or similar. As a result, the documents d in the document group belonging to the similar arrangement group are classified into one or more shared form groups based on a commonality relating to the character string included in the non-empty cells in each document among the documents d in the document group belonging to the similar arrangement group and to the position of the non-empty cells. This enables the efficiency of the classification of the documents d in the document group ds to be improved.

The analysis apparatus 200 may also be configured to identify, between two or more of the documents d in the document group ds belonging to a shared form group, based on a commonality, namely, that the position and character string of the cells including a character string are shared, the item name cells in which the character string represents the name of the item, and to output information indicating the identified item name cells. As a result, the type of item name cells included in the document group belonging to the shared form group can be grasped without using layout attribute information like rulers, cell background color, and cell width.

The analysis apparatus 200 may also be configured to identify, between two or more of the documents d in the document group ds belonging to a shared form group, based on a variability, namely, that the position of the cells including a character string is shared but the character string is different, the item value cells in which the character string represents the value of the item, and to output information indicating the identified item value cells. As a result, the type of item value cells included in the document group belonging to the shared form group can be grasped without using layout attribute information like rulers, cell background color, and cell width.

The analysis apparatus 200 is configured to use a table area, which is a combination of a specific item name cell and a series of item value cells arranged in a row direction or a column direction from that specific item name cell. The analysis apparatus 200 identifies, as shared cells, cells including a character string for which the position and the character string are shared among two or more documents d, and identifies, as variable cells, cells including a character string for which the position is shared but the character string is different among two or more documents d. Then, when, as viewed from a first shared cell present in the same row or column as the specific item name cell, a series of cells arranged in the same direction as a table area include a second shared cell, the analysis apparatus 200 identifies that the second shared cell is an item value cell. The second shared cell is a false item name cell, and thus the identification accuracy of the item name cells and the item value cells can be improved by identifying the false item name cell as an item value cell.

The analysis apparatus 200 is also configured to associate an item name cell and an item value cell based on the positional relation between the item name cell and the item value cell in the documents d belonging to a shared form group, and to output the association result. This enables a single item to be generated in which the item name cell and the item value cell are associated in the documents belonging to the shared form group.

The analysis apparatus 200 is also configured to execute, based on the positional relation between the item name cell and the item value cells in the documents d belonging to a shared form group, association processing for associating and generating as a table an item name cell and a series of item value cells arranged in the row direction or the column direction from that item name cell, and to output the association result. This enables a table to be generated in which the item name cell and a plurality of consecutive item value cells are associated in the documents d belonging to the shared form group.

The analysis apparatus 200 is also configured to identify item name cells having a shared position and item name among all of the documents d belonging to a shared form group, and to output the identification result. This enables the form of documents matching the judgment condition to be identified.

The analysis apparatus 200 is also configured to exclude, from the judgment condition, item name cells having a shared position and item name among the documents d belonging to another shared form group. This enables the form of each shared form group to be uniquely determined.

The analysis apparatus 200 is also configured to control the display screen such that information indicating the item name cells, the item value cells, and an association between those cells is superimposed and displayed on the documents d. This enables the user to confirm whether or not the form definition is correct.

Therefore, according to this embodiment, without using added input, for example, layout attribute information on the documents d and a word dictionary, a large variety and a large amount of system development documents can be classified for each form, and form definition information on each form can be mechanically generated. As a result, the introduction efficiency of a method of converting documents d, like system development documents, and managing the converted documents d in an integrated manner in a database is increased. Even when the above-mentioned method is not introduced, support for understanding the system specification can be given to the person in charge of system maintenance by organizing a large amount of unorganized documents d like system development documents for each form.

It should be noted that this invention is not limited to the above-mentioned embodiments, and encompasses various modification examples and the equivalent configurations within the scope of the appended claims without departing from the gist of this invention. For example, the above-mentioned embodiments are described in detail for a better understanding of this invention, and this invention is not necessarily limited to what includes all the configurations that have been described. Further, a part of the configurations according to a given embodiment may be replaced by the configurations according to another embodiment. Further, the configurations according to another embodiment may be added to the configurations according to a given embodiment. Further, a part of the configurations according to each embodiment may be added to, deleted from, or replaced by another configuration.

Further, a part or entirety of the respective configurations, functions, processing modules, processing means, and the like that have been described may be implemented by hardware, for example, may be designed as an integrated circuit, or may be implemented by software by a processor interpreting and executing programs for implementing the respective functions.

The information on the programs, tables, files, and the like for implementing the respective functions can be stored in a storage device such as a memory, a hard disk drive, or a solid state drive (SSD) or a recording medium such as an IC card, an SD card, or a DVD.

Further, control lines and information lines that are assumed to be necessary for the sake of description are described, but not all the control lines and information lines that are necessary in terms of implementation are described. It may be considered that almost all the components are connected to one another in actuality.

What is claimed is:

1. An analysis apparatus, comprising:
a processor configured to execute a program; and
a storage device configured to store the program and a document group having a spreadsheet format,
the processor being configured to execute:
acquisition processing for acquiring the document group from the storage device;
classification processing for classifying documents in the document group acquired by the acquisition processing into at least one shared form group having a shared form based on a commonality relating to a character string included in a cell of each document among the documents in the document group and to a position of the cell including the character string; and
output processing for outputting a classification result obtained by the classification processing.

2. The analysis apparatus according to claim 1, wherein in the classification processing, the processor is configured to:
classify the documents in the document group into at least one similar arrangement group having, of cell groups in the each document, the same or a similar arrangement of non-empty cells, which are cells including the character string, and empty cells, which do not include the character string; and
classify a document group belonging to the at least one similar arrangement group into the at least one shared form group based on a commonality relating to a character string included in the non-empty cells of each document in the document group belonging to the at least one similar arrangement group and to a position of the non-empty cells.

3. The analysis apparatus according to claim 1,
wherein the processor is configured to execute identification processing for identifying, between at least two documents in the document group belonging to the at least one shared form group, based on a commonality that the position and the character string of the cell including the character string are shared, an item name cell in winch the character string represents a name of an item, and
wherein, in the output processing, the processor is configured to output information indicating the item name cell identified by the identification processing in the document group belonging to the at least one shared form group.

4. The analysis apparatus according to claim 3,
wherein, in the identification processing, the processor is configured to identify, between at least two documents in the document group belonging to the at least one shared form group, based on a variability of the character string that the position of the cell including the character string is shared but the character string of the cell is different, an item value cell in which the character string represents a value of the item, and
wherein, in the output processing, the processor is configured to output information indicating the item value cell identified by the identification processing in the document group belonging to the at least one shared form group.

5. The analysis apparatus according to claim 4, wherein, in the identification processing, the processor is configured to:
identify, by using a table area, which is a combination of a specific item name cell and a series of item value cells arranged in one of a row direction and a column direction from the specific item name cell, cells including the character string for which the position and the character string of the cells are shared between the at least two documents as shared cells, and cells including the character string for which the position of the cells is shared but the character string is different between the at least two documents as variable cells; and
identify, when, as viewed from a first shared cell present in the same row or column as the specific item name cell, a series of cells arranged in the same direction as the table area include a second shared cell, the second shared cell as the item value cell.

6. The analysis apparatus according to claim 4,
wherein the processor is configured to execute association processing for associating the item name cell and the item value cell based on a positional relation between the item name cell and the item value cell in the documents belonging to the at least one shared form group, and
wherein, in the output processing, the processor is configured to output an association result obtained by the association processing.

7. The analysis apparatus according to claim 4,
wherein the processor is configured to execute association processing for associating and generating as a table the item name cell and a series of item value cells arranged in one of a row direction and a column direction from the item name cell based on a positional relation between the item name cell and the item value cells in the documents belonging to the at least one shared form group, and
wherein, in the output processing, the processor is configured to output an association result obtained by the association processing.

8. The analysis apparatus according to claim 4,
wherein the processor is configured to execute condition identification processing for identifying an item name cell in which the position and the item name are shared by all the documents belonging to the at least one shared form group as a judgment condition for judging a form of the documents, and
wherein, in the output processing, the processor is configured to output an identification result obtained by the condition identification processing.

9. The analysis apparatus according to claim 8, wherein, in the condition identification processing, the processor is configured to exclude from the judgment condition an item name cell having a position and an item name that are shared by a document belonging to another shared form group.

10. The analysis apparatus according to claim 3, wherein, in the output processing, the processor is configured to control a display screen to superimpose and display the document and information indicating the item name cell.

11. An analysis method to be executed by an analysis apparatus,
the analysis apparatus comprising:
a processor configured to execute a program; and
a storage device configured to store the program and a document group having a spreadsheet format,
the analysis method, which is executed by the processor, comprising:
acquiring the document group from the storage device;
classifying documents in the document group acquired by the acquisition processing into at least one shared form group having a shared form based on a commonality relating to a character string included in a cell of each document among the documents in the document group and to a position of the cell including the character string; and
outputting a classification result obtained by the classification processing.

12. A non-transitory processor-readable recording medium having stored thereon an analysis program to be executed by a processor capable of accessing a storage device configured to store a document group having a spreadsheet format, the analysis program causing the processor to execute:
acquisition processing for acquiring the document group from the storage device;
classification processing for classifying documents in the document group acquired by the acquisition processing into at least one shared form group having a shared form based on a commonality relating to a character string included in a cell of each document among the documents in the document group and to a position of the cell including the character string; and
output processing for outputting a classification result obtained by the classification processing.
